(19) United States
(12) Patent Application Publication
(10) Pub. No.: US 2014/0037383 A1
(43) Pub. Date: Feb. 6, 2014

(54) TRACER WIRE INSTALLATION DEVICES AND METHODS FOR TRENCHLESS UTILITY REPLACEMENT

(71) Applicant: Natalino J. Giraldi, Bronx, NY (US)

(72) Inventor: Natalino J. Giraldi, Bronx, NY (US)

(21) Appl. No.: 13/563,161

(22) Filed: Jul. 31, 2012

(51) Int. Cl. F16L 55/00

(52) U.S. Cl. 405/157

(57) ABSTRACT

Devices and methods for trenchlessly replacing an existing utility pipe with a replacement pipe and a tracer wire are described in this application. A replacement pipe may be joined to the head adaptor of a trenchless splitter tool with a tracer wire being trapped between them, resulting the tracer wire extending from within the replacement pipe through a joint to the exterior of the replacement pipe. A protective cap (or deflector) may be placed of the portion of tracer wire extending from the joint. The splitter tool may then be introduced into and travelled along the existing pipe, splitting and displacing the existing pipe, and placing replacement pipe and tracer wire along the path of the existing pipe, thereby functionally replacing the existing pipe with a replacement pipe and a tracer wire. Other embodiments are described.

### FIELD

This application relates generally to location of underground utilities. More specifically, this application relates to systems and methods for installing a tracer wire for locating parts of a buried utility (gas, water, sewer, or electric) distribution system.

### BACKGROUND

Natural gas distribution has become an important utility and a key provider for heat around the world. Maintenance and repair of natural gas (or gases) lines can be very important due to the danger of gas leaks and the critical importance to customers of natural gas in continued supply for many uses, such as cooking, air heating, use by water heaters, clothes dryers, etc. Similarly, distribution systems for other utilities (including water, sewer, or electric) also need repair or replacement.

Most utility—including gas—lines are buried along streets that also include other utilities. Often, to repair a damaged or clogged gas line, such as a gas main or branch, a hole must be excavated and the pipe checked or replaced. Currently, the technology to determine the exact locations of the gas mains, especially at elevated pressures, in a confident manner does not exist. One reason is that most gas lines are now made from HDPE (high-density polyethylene), which is very difficult to locate underground. Some technicians are trained to approximate where the gas lines are and provide mark outs on the ground where the gas line should be. The mark outs, even when provided, are based upon map accuracy and the expertise of the technician. The technician often picks up other utilities normally running alongside gas mains, which the gas repair crews do not want to disturb. Often, errors in the mark outs can still be off by as much as 3 to 4 feet, which causes extra time and effort in excavation and avoiding other utilities, along with added costs in repairing roads and service delays.

### SUMMARY

This application describes devices and methods for replacing existing utility pipes with replacement pipes without using a trench. To replace the existing pipe with a replacement pipe coupled with a tracer wire, a trenchless pipe replacement splitter tool can be coupled to a head adaptor formed of HDPE. A replacement pipe may be joined to the head adaptor with the tracer wire being trapped between the head adaptor and the replacement pipe. The head adaptor and the replacement pipe may be formed of HDPE (or other suitable natural gas pipe material) and the joint between the head adaptor and the replacement pipe may be formed by melting them together, resulting in the tracer wire extending from within the replacement pipe through the joint and then to the exterior of the replacement pipe. A protective cap (or deflector) may be placed of the portion of the tracer wire extending from the joint. The protective cap may be attached to the replacement pipe using spikes formed in the protective cap, with fasteners, and/or by melting the protective cap to the pipe. A splitter tool may be introduced into the existing pipe and while it travels along the existing pipe, it splits and displaces the existing pipe. In the process, a replacement pipe and tracer wire can be placed along the path of the existing pipe, thereby functionally replacing the existing pipe with a replacement pipe and a tracer wire. The tracer wire may then be used in to locate the replaced gas supply line. These devices can also be used in flow mole methods that use a water jet boring tool, a hole hog tool that is utilized for new installations, and directional boring methods for new installations.

### BRIEF DESCRIPTION OF THE DRAWINGS

The following description can be better understood in light of the Figures, in which:

FIG. 1 shows an isometric view of some embodiments of a tool for trenchless gas line replacement and an exemplary tracer wire installation assembly;

FIG. 2 shows a cross-sectional view of some embodiments of the exemplary tracer wire installation assembly of FIG. 1;

FIG. 3 shows some embodiments of the exemplary tracer wire installation assembly without a protective cap;

FIGS. 4 and 5 show some embodiments of a protective cap for tracer wire installation in trenchless gas line replacement;

FIGS. 6 and 7 show some embodiments of an exemplary tracer wire installation assembly for trenchless gas line replacement; and

FIG. 8 shows a cross-sectional view of some embodiments of a tool for trenchless gas line replacement and an exemplary tracer wire installation assembly during installation.

The Figures illustrate specific aspects of tracer wire installation assemblies for use in trenchless gas line replacements and methods for making and using such devices. Together with the following description, the Figures demonstrate and explain the principles of the methods and structures produced through these methods. In the drawings, the thickness of layers and regions are exaggerated for clarity. The same reference numerals in different drawings represent the same element, and thus their descriptions will not be repeated. As the terms on, attached to, or coupled to are used herein, one object (e.g., a material, a layer, a substrate, etc.) can be on, attached to, or coupled to another object regardless of whether the one object is directly on, attached, or coupled to the other object or there are one or more intervening objects between the one object and the other object. Also, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements.

### DETAILED DESCRIPTION

The following description supplies specific details in order to provide a thorough understanding. Nevertheless, the skilled artisan would understand that the described tracer wire installation assemblies for use in trenchless gas line replacements and methods for making and using such devices can be implemented and used without employing these specific details. Indeed, the tracer wire installation assemblies can be placed into practice by modifying the illustrated devices and methods and can be used in conjunction with any other apparatus and techniques conventionally used in the industry. For example, while the description below focuses on methods of replacing gas lines with a splitter having an eccentric body and sail, any device for trenchless replacement of gas lines may be used with the described tracer wire installation assemblies.

Some embodiments of tracer wire installation assemblies for use in trenchless utility line replacements and methods for making and using such devices are described herein and illustrated in the Figures. These assemblies and methods can be used with any utility line, including gas, water, sewer, electric, or any other utility. In some embodiments, these assemblies and methods can be used with gas lines.

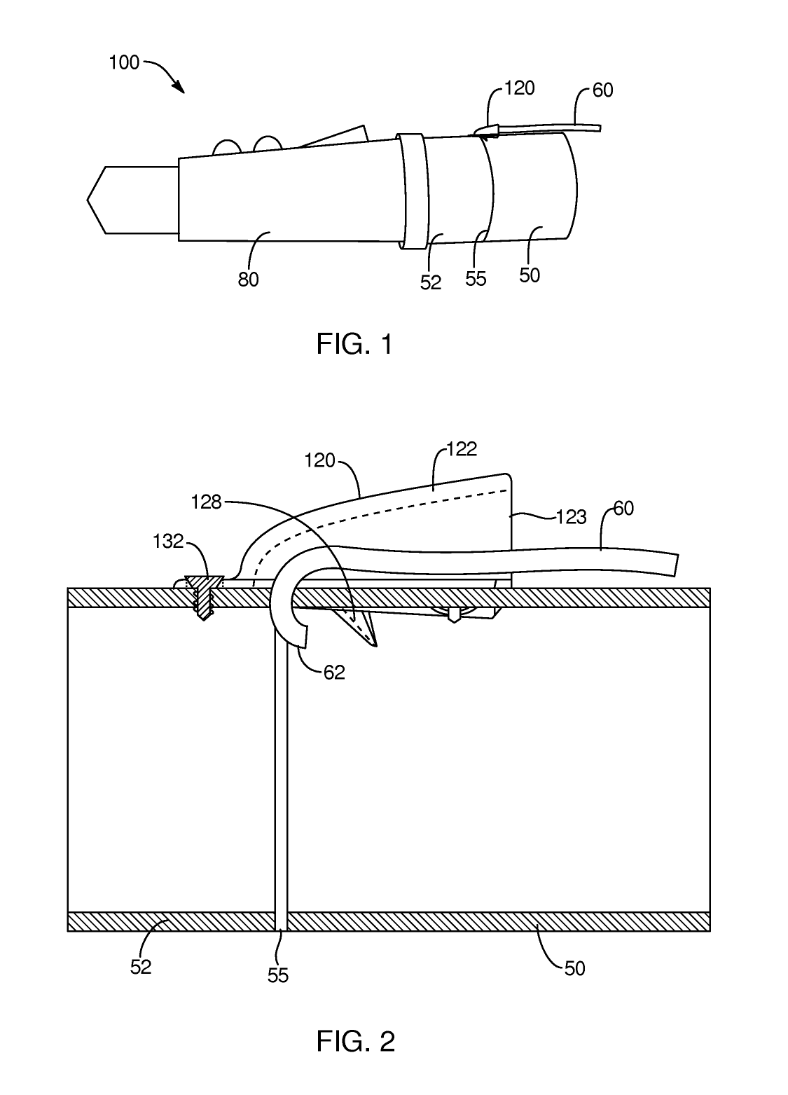

FIGS. 1-2 illustrate some embodiments of a tracer wire installation assembly 100 along with a splitter tool 80 and replacement pipe 50. The tracer wire installation assembly 100 may contain both a protective cap 120 and a tracer wire 60. In these illustrated configurations, the splitter tool 80 may be coupled to a head adaptor 52 which, in turn, may be joined to replacement pipe 50.

The splitter tool 80 may comprise any apparatus capable of replacing an existing natural gas pipe with a replacement pipe. For example, the splitter tool may comprise a PIP Consplit® tool. The existing natural gas pipe may be metal, plastic, or any material used to convey natural gas(es). Similarly, the existing natural gas pipe may be of any size used to convey natural gas and the replacement pipe may be of a similar size, may be smaller than, or even slightly larger than the existing pipe it is replacing, depending on the capabilities of the splitter tool 80.

The tracer wire 60 may be any wire which may be used for tracing from above the ground with locating tools. For example, the tracer wire 60 may be a bare wire formed of any suitable metal, or the tracer wire may be a jacketed solid or stranded conductor. When jacketed, the jacket may be formed of any material, such as HDPE or other insulating or protective wire jacket material. In some embodiments, the jacket may be resistant to damage from being drawn through the earth in a trenchless installation procedure, such as those described herein. Similarly, the jacket may include additional protective layers such as Kevlar or other materials. In some configurations, the tracer wire contains a transmitter that is utilized to trace the wire installation.

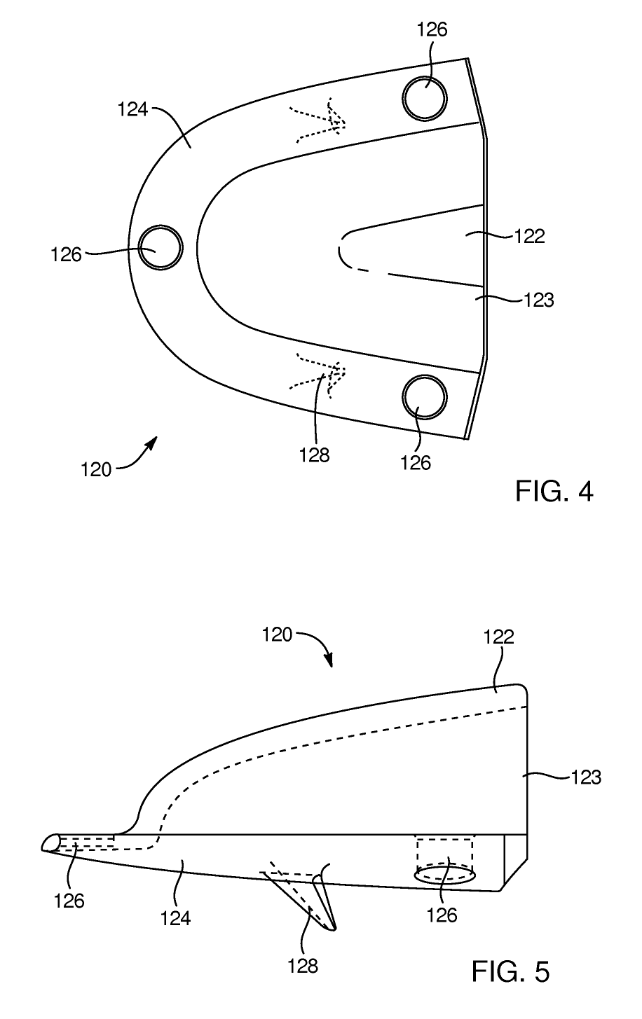

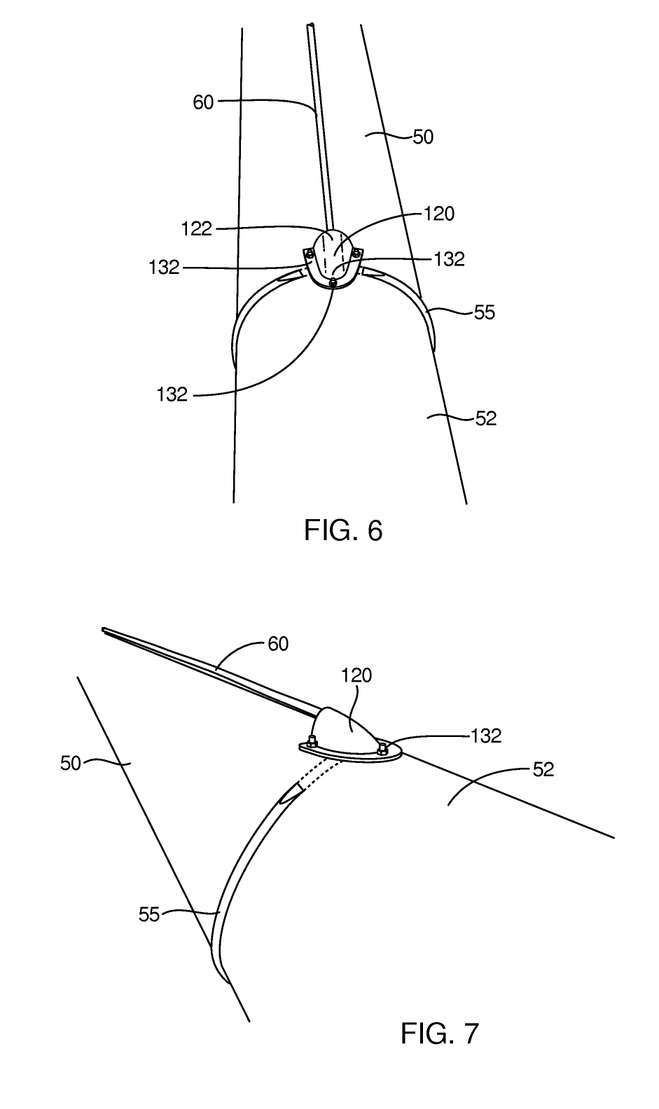

FIGS. 2-8 illustrate various stages of installing the replacement pipe 50 and the tracer wire 60. When installing HDPE gas pipe, sections of the pipe may be joined by melting two ends together to form a continuous pipe. The joining process may be done by placing the two ends of the pipe to be joined in a jig that properly aligns the ends. Tools may then be used to trim the ends to be joined and then the ends are heated to the melting point of the HDPE. The jig may be used to then press the melted ends together, fusing or welding the two ends and forming a continuous pipe.

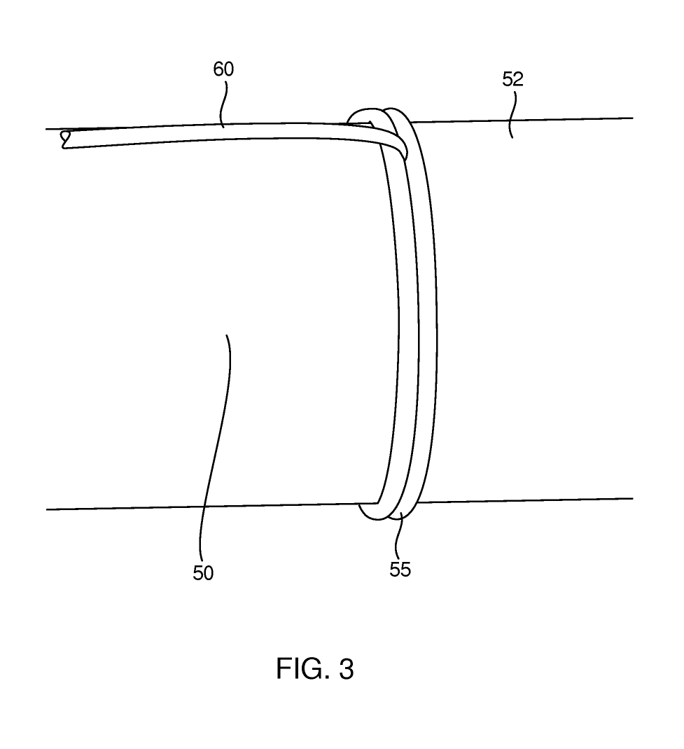

In preparing to use the splitter tool 80, the head adaptor 52 may be attached to the splitter tool 80 with mechanical fasteners (not shown). The head adaptor 52 may comprise a short piece of HDPE pipe to allow for easy connection with the replacement pipe 50. The head adaptor 52 may be joined to the replacement pipe 50, as described above, thereby creating a joint 55 where the head adaptor 52 and the replacement pipe 50 are melted together in preparation for installation of the replacement pipe 50. As shown in FIGS. 2 and 3, an end 62 of the tracer wire 60 may then be placed between the head adaptor 52 and the replacement pipe 50 during the joining process such that the tracer wire is trapped in the joint 55 when the pipes are joined together. When the tracer wire 60 comprises a HDPE jacket, the jacket may be melted into the joint 55, creating a very strong attachment to replacement pipe 50 and head adaptor 52. The tracer wire 60 may be placed in the joint 55 and aligned with the sail portion of splitter tool 80 such that the tracer wire is positioned in the split of the existing pipe, thereby providing some protection for the wire from the surrounding earth and existing pipe.

Optionally, a protective cap 120 (as shown in FIGS. 2 and 4-7) may be used to further protect the tracer wire 60 from damage during the installation process. The protective cap 120 may include a flare 120 providing an opening 123 for the tracer wire to extend from the protective cap 120 when in position over the joint 55. The protective cap 120 may also include a lip 124 shaped to mate with an outside surface of the replacement pipe 50 and the head adaptor 52. The lip 124 may have holes 126 for fasteners 132 to fix the protective cap to the pipe. Additionally, the protective cap 120 may include spikes 128, which may be driven into the pipe or inserted into holes made in the pipe. The spikes 128 may be angled towards the replacement pipe 50 to provide resistance to materials pushing the protective cap 120 off of the pipe. Since the protective cap (or shield) may be installed over the joint 55, which may have a bead formed in the joint, the bead can be removed in the area where the protective cap 120 is to be mounted in order to set the shield substantially flush to the HDPE utility lines.

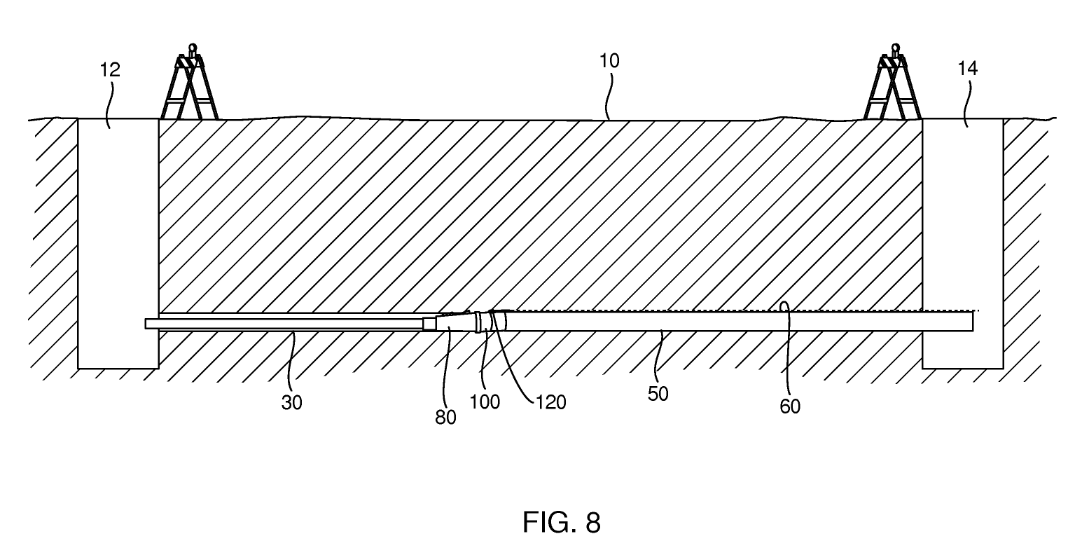

In some configurations, the protective cap 120 may be formed of metal and heated to a temperature higher than the melting temperature of the pipe. The shield can then be placed over the entry point of the wire installation and set screwed with screws. The spikes can allow for added reinforcement to prevent slippage of the shield. The protective cap 120 may then be pressed into the pipe and the spikes will penetrate the outer surface of the HDPE from the inward pressure of the screws which set the shield in place. The spikes can melt into the pipe and the lip 124 conforming to the outside surface of the pipe 50, 52. The fasteners 132 may then be used to further secure the protective cap in place. In other embodiments, a matching number of holes may be drilled for the spikes. As shown in FIG. 2, the protective cap 120 may be placed over the joint 55 such that the tracer wire 60 is covered and extends out of the opening 123 of the protective cap. The protective cap may be positioned such that the opening 123 opens towards the replacement pipe 50 and away from the splitting tool 80 to provide a smooth surface in the direction that the splitter tool 80 and replacement pipe 50 will be pulled through the existing pipe 30 during installation as shown in FIG. 8. The result is that the protective cap 120 can act as a deflector to prevent material and debris from engaging the point where the tracer wire 60 extends from the joint 55.

The protective cap 120 may be formed of any material that provides protection to the tracer wire 60 at the joint 55. Examples of such materials include steel, aluminum, other metals and alloys, and/or plastics such as HDPE or poly-carbonate. In some embodiments, the protective cap 120 may be formed by stamping, machining, molding, or any other manufacturing process.

As shown in FIG. 8, the replacement pipe 50 may replace the existing pipe 30 by attaching replacement pipe 50 to splitter tool 80 and then drawing the splitter tool 80 through the existing pipe 30. As illustrated, hole 14 represents an origination and hole 12 a terminus for the pipe replacement between the two holes. To replace the existing pipe 30 with the replacement pipe 50 along with the tracer wire 60, the splitter tool 80 may be placed into the existing pipe 30 through the hole 14. The splitter tool 80 may then be pulled with a cable or pushed by replacement pipe 50 to drive the splitter tool 80 through the existing pipe 30 towards the hole 12. As it moves towards hole 12, the splitter tool 80 splits the existing pipe 30, thereby placing the replacement pipe 50 and the tracer wire 60 between holes 12 and 14 in the space previously occupied by the existing pipe 30.

Thus, in some embodiments, to replace the existing pipe 30 with a replacement pipe 50 and a tracer wire 60, a trenchless pipe replacement splitter tool 80 may be coupled to a head adaptor 52 formed of HDPE. A replacement pipe 50 may be joined to the head adaptor 52 with the tracer wire being trapped between the head adaptor 52 and the replacement pipe 50. The head adaptor 52 and the replacement pipe 50 may be formed of HDPE, or other natural gas pipe material, and the joint 55 between the head adaptor 52 and the replacement pipe 50 may be formed by melting them together, resulting the tracer wire 60 extending from within the replacement pipe 50 through the joint 55 to the exterior of the replacement pipe 50. A protective cap 120 (or deflector) may be placed of the portion of tracer wire 60 extending from the joint 55. The protective cap 120 may be attached to replacement pipe using spikes formed in the protective cap 120, with fasteners, or both, or by some other suitable attachment method such as melting the protective cap to the pipe. The splitter tool 80 may then be introduced into and travelled along the existing pipe 30, splitting and displacing the existing pipe 30, and placing replacement pipe 50 and tracer wire 60 along the path of the existing pipe 30, thereby functionally replacing the existing pipe 30 with a replacement pipe 50 and a tracer wire 60.

The devices and methods for replacing existing natural gas supply pipes without using a trench provide several features. First, it can be easier to install a tracer wire along with the replacement pipe. Some conventional methods avoid losses and delays in locating buried gas pipes by running a tracer wire with the buried pipe that can be located from the surface. However, these methods are generally only effective when a trench is opened for the new pipe. But many new gas lines are installed by using placing a new pipe in place of an old pipe without having to dig a trench. This replacement is done by placing a tool connected to the new, replacement HDPE pipe into the existing pipe at an entry point and pulling through the pipeline to an exit point. The old pipe is then split open and expanded out into the soil, allowing the replacement pipe to be pulled into the enlarged hole immediately behind the tool. As the tool moves through the old pipe, two cutting wheels press a deep cut into the interior pipe wall. The eccentric body of the tool concentrates stress at the cut, which tears the pipe along the cut and opens it smoothly without high pulling forces. A sail blade located between the cutting wheels and eccentric body cuts through repair clamps. When the splitting operation is complete, the replacement pipe has been simultaneously installed. However, because of the lack of a trench, and earth and old pipe scraping against the replacement pipe, it has been difficult to install a tracer wire along with the replacement pipe in this way.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation, and use may be made without departing from the principles and concepts set forth herein. Also, as used herein, the examples and embodiments, in all respects, are meant to be illustrative only and should not be construed to be limiting in any manner.

1. A method of placing a tracer wire underground along a utility pipe, comprising:
placing a tracer wire between two pipe sections;
connecting the two pipe sections to form a joint with the tracer wire extending from the joint;
covering at least a portion of the joint with a protective cap; and
causing the two pipe sections to travel underground.

2. The method of claim 1, wherein the two pipe sections are sections of a natural gas supply line.

3. The method of claim 1, wherein connecting the two pipe sections is accomplished by melting abutting ends of the two pipe sections together to form one continuous pipe section.

4. The method of claim 1, wherein one of the two pipe sections is connected to an underground pipe splitter tool.

5. The method of claim 1, wherein the two pipe sections are formed of HDPE.

6. The method of claim 1, wherein the tracer wire contains a jacket comprising HDPE.

7. The method of claim 6, wherein the jacket is melted onto each of the two pipe sections when the connecting the two pipe sections.

8. The method of claim 1, wherein the two pipe sections travel underground and functionally replace an existing pipe in the ground.

9. The method of claim 1, wherein the protective cap includes at least one spike extending into at least one of the two pipe sections.

10. The method of claim 1, wherein the protective cap is affixed to at least one of the two pipe sections with at least one fastener.

11. The method of claim 1, wherein the protective cap is formed of metal.

12. A method of replacing a buried pipe with a replacement pipe and tracer wire, comprising:
connecting a trenchless pipe replacement splitter tool to a head adaptor;
placing a tracer wire between the head adaptor and a section of replacement pipe;
fusing the head adaptor to the section of replacement pipe, trapping a portion of the tracer wire between the head adaptor and the section of replacement pipe;
introducing the splitter tool into an origination opening of an existing pipe; and
travelling the splitter tool through the existing pipe to a terminus opening, thereby placing the replacement pipe and the tracer wire between the origination opening and the terminus opening.

13. The method of claim 12, further comprising covering the trapped portion of the tracer wire.

14. The method of claim 13, wherein the covering the trapped portion of the tracer wire is accomplished by attaching a deflector to the section of replacement pipe.

15. The method of claim 14, wherein the attaching is done by at least one of:
attaching with fasteners;
extending spikes from the deflector into the section of replacement pipe; and
heating the deflector and melting the deflector into the replacement pipe.

16. The method of claim 12, wherein the tracer wire has a jacket formed of HDPE.

17. The method of claim 12, wherein the fusing is accomplished by heating and melting together an end of the head adaptor and an end of the replacement pipe.

18. The method of claim 17, wherein the head adaptor and the replacement pipe are formed of HDPE.

19. The method of claim 12, further comprising using a locator tool to locate the underground tracer wire.

20. The method of claim 1, wherein the two pipe sections are sections of a water, sewer, or electric supply line.
